(19) United States
(12) Patent Application Publication
(10) Pub. No.: US 2004/0220730 A1
(43) Pub. Date: Nov. 4, 2004

(54) Off-road navigation system

(75) Inventors: Kuo-Rong Chen, Panchiao City (TW); Chun-Chung Lee, Taipei (TW); Cheng-Hung Huang, Miaoli (TW)

Correspondence Address: BACON & THOMAS, PLLC, 625 SLATERS LANE, FOURTH FLOOR, ALEXANDRIA, VA, 22314

(73) Assignee: Sin Etke Technology Co., Ltd., Taipei City (TW)

(21) Appl. No.: 10/638,434

(22) Filed: Aug. 12, 2003

(30) Foreign Application Priority Data
May 2, 2003 (TW) 92112125

(51) Int. Cl. G01C 21/34

(52) U.S. Cl. 701/210; 701/202; 340/995.21

(57) ABSTRACT

An off-road navigation system in which an off-road route database is installed in a remote control center and having stored therein a plurality of off-road routes, each off-road route having a starting point and an off-road destination located at a place where no accomplished road can reach. When a vehicle wirelessly sent to the remote control center an off-road navigating request including the data of the desired off-road destination, the server of the remote control center searches the off-road route database for a specific off-road route corresponding to the off-road destination, and wirelessly sends the data of the specific off-road route to the vehicle in response to the navigating request for guiding the driver to the off-road destination through turning points in the specific off-road route.

### BACKGROUND OF THE INVENTION

1. Field of the Invention The present invention relates to a navigation system and, more particularly, to an off-road navigation system that provides an off-road route for navigation.

2. Description of Related Art

There is known a conventional on-board navigation system adapted to provide a guiding route for guiding the vehicle driver to the destination. When the driver wishing to find a route for navigation, it is necessary to input the destination into the on-board navigation system, driving the on-board navigation system to search the electronic map database for the turning points between the current position of the vehicle and the destination and the related directional information, so that the on-board navigation system can compare the current position of the vehicle with the coordinates of the next turning point and display the related directional information on the display installed in the vehicle to guide the driver to the destination at anytime during running of the vehicle.

There is another conventional “simple” on-board navigation system, which is designed to wirelessly transmit the coordinates of the current position of the vehicle as well as the destination to a remote control center, enabling the server of the remote control center to search its electronic map database for the turning points and the related direction information between the current position of the vehicle and the destination and then wirelessly send the searched data to the on-board navigation system of the vehicle for guiding the vehicle to the destination. Thus this design can save much the installation cost of the on-board navigation system.

However, the electronic map databases used in the aforesaid two on-board navigation systems simply store the information of accomplished roads, for example, freeways, highways, city streets, small village roads, or industrial roads. If the destination is a particular geographical location or particular landscape where there is no any accomplished road to reach, for example, when playing outdoor sports such as stream-tracing, sand-racing, or hot-spring-tracing, the aforesaid two on-board navigation systems cannot calculate a cross-country route, or the so-called off-road route, to guide the vehicle to the destination.

Therefore, it is desirable to provide an off-road navigation system that eliminates the aforesaid drawbacks.

### SUMMARY OF THE INVENTION

It is the main object of the present invention to provide an off-road navigation system, which provides a cross-country guiding route to guide the vehicle to the destination without accomplished roads.

It is another object of the present invention to provide an off-road navigation system, which updates cross-country route information on time so as to increase the safety and accuracy of the cross-country guiding route.

To achieve these and other objects and according to one aspect of the present invention, an off-road navigation system is installed in a remote control center, comprising a remote server, a wireless communication module, and an off-road route database. The wireless communication module is adapted to wirelessly receive an off-road navigating request which including the position data of an off-road destination. The off-road destination is located at a specific geographical location where no accomplished road can reach. The off-road route database has stored therein a plurality of off-road routes. The off-road routes include at least one specific off-road route corresponding and reaching to the off-road destination. The off-road routes each have a starting point. The remote server is adapted to search the off-road route database for the at least one specific off-road route corresponding to the off-road destination of the off-road navigating request, and to control the wireless communication module to wirelessly send out the at least one specific off-road route in response to the off-road navigating request.

According to another aspect of the present invention, an on-board off-road navigation system is installed in a vehicle. The on-board off-road navigation system comprises a global positioning module adapted to calculate the current position of the vehicle; a wireless communication module adapted to wirelessly send out an off-road navigating request and to wirelessly receive at least one specific off-road route, the off-road navigating request including the position data of an off-road destination, the off-road destination being located at a specific geographical location where no accomplished road can reach, the at least one specific off-road route each including an off-road navigation data traveling from a respective starting point to the off-road destination; and a second navigation apparatus adapted to fetch the current position of the vehicle from the global positioning module, and to guide the vehicle to the off-road destination subject to the off-road navigation data of the at least one specific off-road route.

The aforesaid global positioning module can be a GPS (global positioning system) module, or any of a variety of equivalent global positioning devices that can calculate the current position of the vehicle. The aforesaid wireless communication module can be a GPRS (general packet radio service) module, GSM (global system for mobile communication) module, 3C (computer, communication, consumer electronics) module, a bluetooth module, an 802.11 module, or any of a variety of equivalent wireless communication devices that can wirelessly transmit/receive voice signal, short message, or digital data, or transmit/receive message through broadcasting.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing showing the system architecture of an off-road navigation system according to the first embodiment of the present invention;

FIG. 2 is a bird's-eye view of a specific off-road route according to the first embodiment of the present invention;

FIG. 3 is a schematic drawing showing the content displayed on the display screen according to the first embodiment of the present invention;

FIG. 4 is a schematic drawing showing the actual off-road route to the off-road destination according to the first embodiment of the present invention;

FIG. 5 is schematic drawing showing the system architecture of an off-road navigation system according to the second embodiment of the present invention;

FIG. 6 is a bird's-eye view of specific off-road routes and guiding routes according to the second embodiment of the present invention; and

FIG. 7 is a schematic drawing showing the system architecture of an off-road navigation system according to the third embodiment of the present invention.

### DETAILED DESCRIPTION OF THE PREFERRED EMBODIMENT

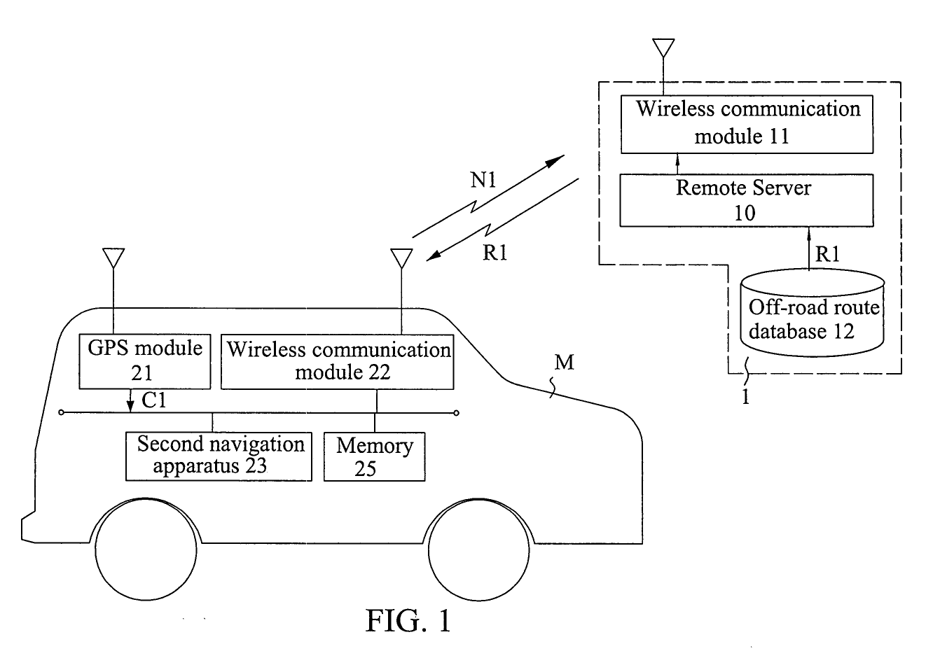

FIG. 1 illustrates the system architecture of an off-road navigation system according the first embodiment of the present invention. The off-road navigation system includes an on-board off-road navigation unit installed in a vehicle M, which on-board off-road navigation unit comprises a GPS (global positioning system) module 21, a wireless communication module 22, a second navigation apparatus 23, and a memory 25, and a remote control center 1, which comprises a remote server 10, a wireless communication module 11, and an off-road route database 12.

The wireless communication module 22 of the vehicle M and the wireless communication module 11 of the remote control center 1 can communicate with each other. According to this embodiment, the wireless communication module 11 and 22 are GPRS (general packet radio service) apparatuses that can wirelessly transmit and receive messages by voice, short message, or digital data.

The off-road route database 12 has stored therein the information of a plurality of off-road routes. Each off-road route goes from a starting point through a number of turning points to an off-road destination without accomplished road. The starting point of every off-road route can be located on an accomplished road, or any turning point of one of the off-road routes. The off-road routes may be ended at the off-road destination, or pass through the off-road destination to other turning points.

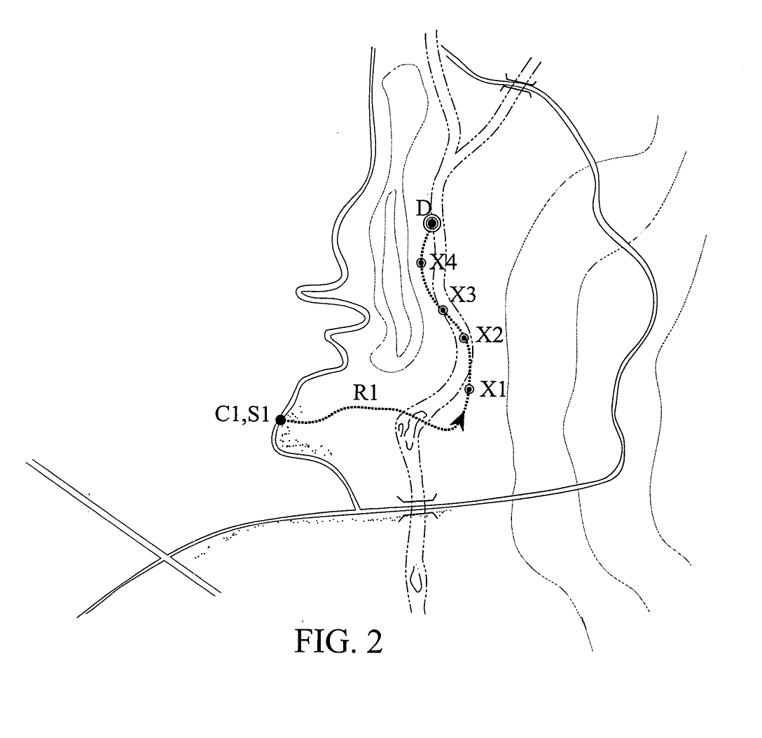

Please also refer to FIG. 2, when wishing to drive the vehicle M to an off-road destination D, such as a hot spring by the side of a wild stream, the driver can wirelessly send an off-road navigating request N1 to the remote control center 1 by means of the wireless communication system 22 of the vehicle M. The off-road navigating request N1 includes all the position data of the off-road destination D.

Referring to FIGS. 1 and 2 again, because the off-road destination is a hot spring by the side of a wild stream, the driver must drive the vehicle M along a narrow path in the mountain to go upstream. When the wireless communication module 11 of the remote control center 1 received the off-road navigating request N1, the remote server 10 searches the off-road route database 12 for a corresponding specific off-road route RI including a number of turning points X1,X2,X3,X4 and the related off-road navigation data subject to the data of the off-road destination D provided, and then wirelessly send the searched data of the specific road-road route R1 and the related off-road navigation data to the wireless communication module 22 by the wireless communication module 11 of the remote control center 1 in response to the off-road navigating request N1, enabling the wireless communication module 22 to store the received data in the memory 25 (which can be, for example, an IC memory card).

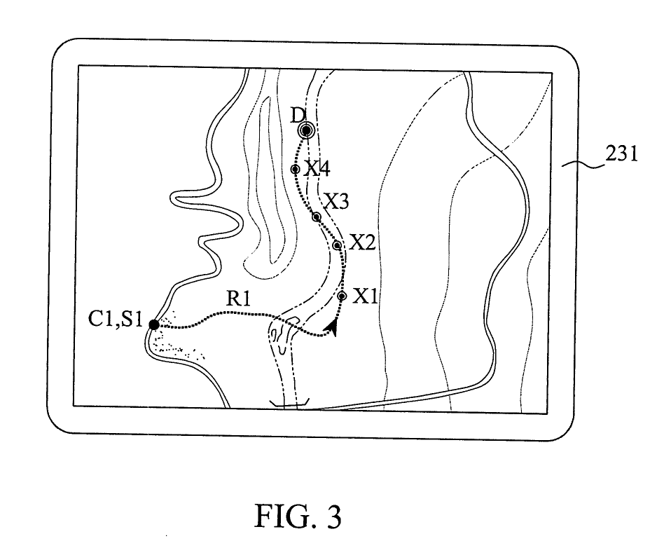

As illustrated in FIG. 2, the departure point C1 of the vehicle M is just the starting point S1 of the aforesaid specific off-road route R1 and on an accomplished road. At this time, the second navigation apparatus 23 fetches the current position of the vehicle M from the GPS module 21 and compares the fetched data to the specific off-road route R1 stored in the memory 25, and then shows the comparison result on the display screen 231 of the second navigation apparatus 23 shown in FIG. 3 to guide the driver from the starting point S1 to the off-road destination D via the turning points X1,X2,X3,X4. The second navigation apparatus 23 may further prompt the driver with the related off-road navigation data by voice when the driver driving the vehicle M to the off-road destination D.

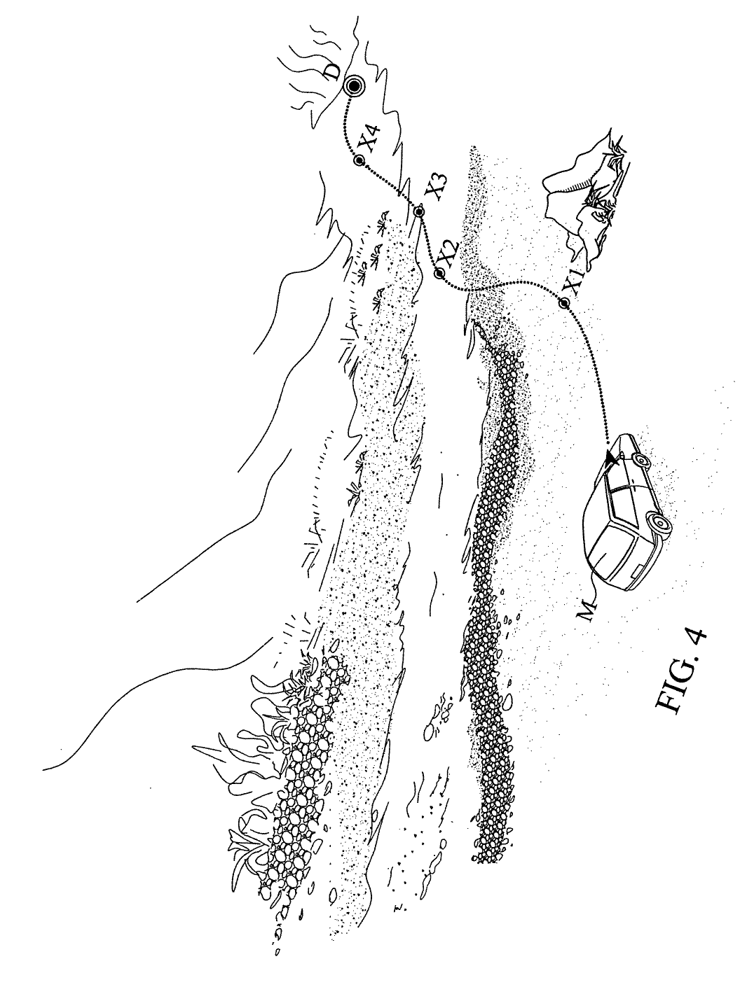

With reference to FIG. 4, when tracing upstream, the driver drives the vehicle M along the right bank of the stream to the first turning point X1 nearby a big rock, and then turns the vehicle M to the left, and then drives the vehicle M across the stream through the second turning point X2 to the third turning point X3 at the left bank of the stream, and then drives the vehicle M from the third turning point X3 toward the fourth turning point X4 and then reaches the off-road destination D. Stream side rocks, roadside big trees, turnouts, or any outstanding landmarks in the off-road route may be used to guide the driver to the destination.

The off-road routes (for example, stream-tracing routes, sand-racing routes, or hot-spring-tracing routes) stored in the off-road route database 12 are preferably obtained by the remote control center 1 by: assigning people to survey specific landscape spots or off-road destinations and collect the data of every turning point, and then recording surveyed and collected data in the off-road route database 12. Because the off-road routes are located in the desolate area, they may be caused by the weather (such as earthquake, landslide, and storm) to divert their way. The remote control center 1 may regularly or irregularly assign people to survey the off-road routes so that the off-road route database 12 can be updated on time. The clients or collaborated groups of vehicles may provide a report actively to the remote control center 1 after a driving through the off-road routes, enabling the remote control center 1 to update the content of the off-road route database 12. Therefore the remote control center 1 can wirelessly send the updated data of the off-road route database 12 to the vehicle M on time, improving the safeness of accuracy of the off-road routes.

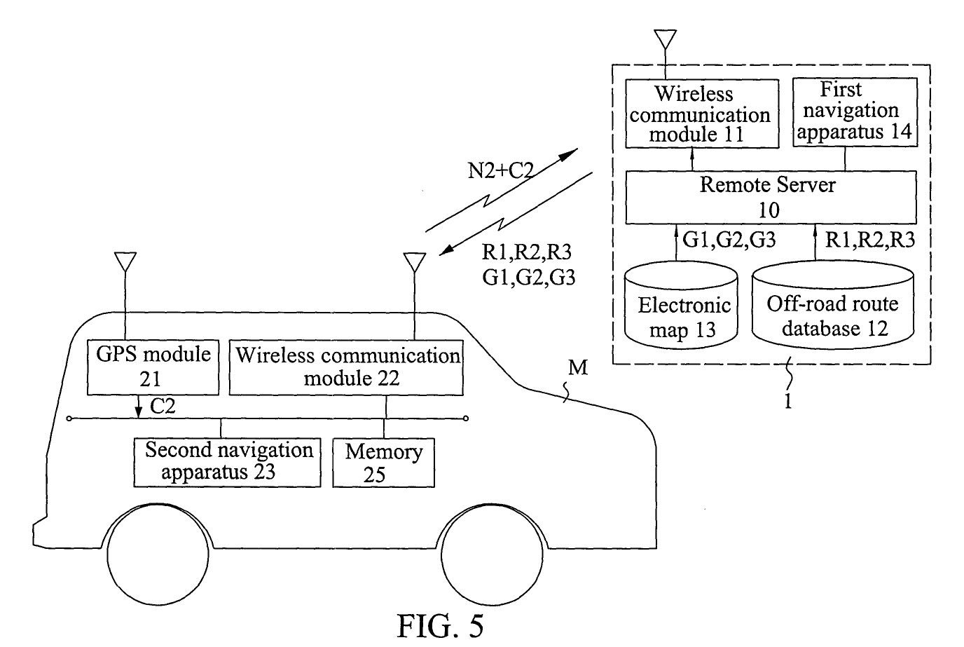

FIG. 5 illustrates the system architecture of the second embodiment of the present invention. This alternate form is substantially similar to the aforesaid first embodiment with the exception of the added electronic map 13 and first navigation apparatus 14 in the remote control center 1. The electronic map 13 is adapted to store the data of a plurality of accomplished roads.

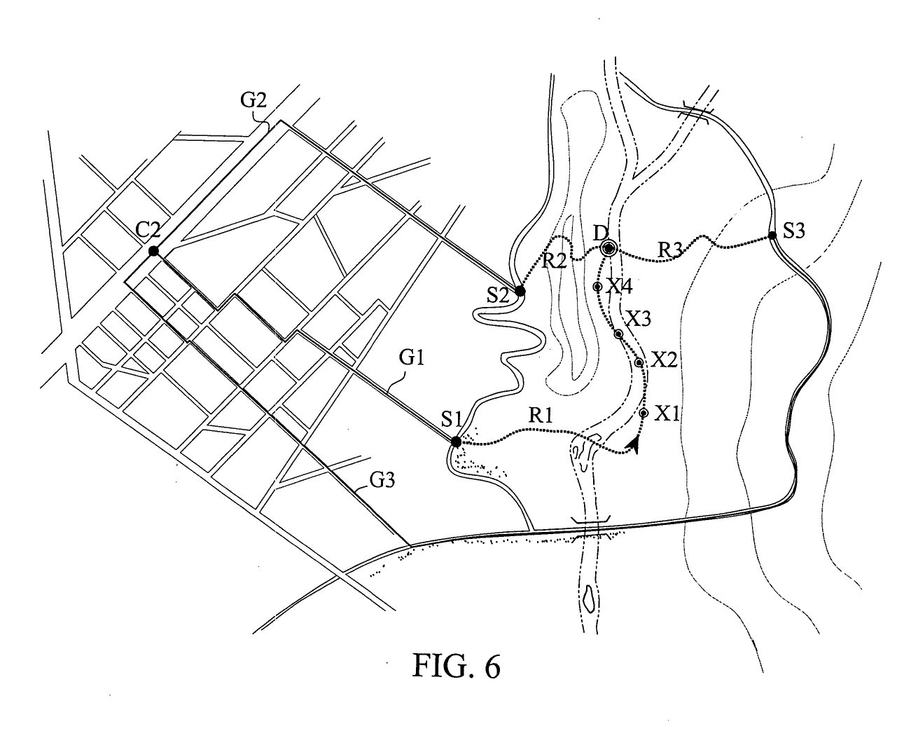

Referring to FIG. 6 and FIG. 5 again, the departure point C2 is the current position of the vehicle M which is on an accomplished road in a city (remote from the mountainside). When the wireless communication module 11 of the remote control center 1 received an off-road navigating request N2 including an off-road destination D and the coordinates of the departure point C2 from the vehicle M, the remote server 10 searches the off-road route database 12 subject to the provided data of the desired wild stream hot spring located at the off-road destination D, and obtains three specific off-road routes R1,R2,R3 to the wild stream hot spring from the search result. The specific off-road routes R1,R2,R3 each has a starting point S1,S2,S3 located on an accomplished road. Thereafter, the first navigation apparatus 14 searches the electronic map 13 for the respective corresponding guiding routes G1,G2,G3 formed based on accomplished roads from the departure point C2 to the respective starting points S1,S2,S3, and then wirelessly send the data of the specific off-road routes R1,R2,R3 and the respective guiding routes G1,G2, G3 to the wireless communication module 22 of the vehicle M in response to the off-road navigating request N2, enabling the wireless communication module 22 to store the received data in the memory 25.

As a result, the remote control center 1 figured out three suggested routes from the departure point C2 of the vehicle M to the desired off-road destination D as follows:

(1) departing from the departure point C2, and then going through the guiding route G1 to the starting point S1, and then moving along the corresponding specific off-road route R1 to the off-road destination D;

(2) departing from the departure point C2, and then going through the guiding route G2 to the starting point S2, and then moving along the corresponding specific off-road route R2 to the off-road destination D; and

(3) departing from the departure point C2, and then going through the guiding route G3 to the starting point S3, and then moving along the corresponding specific off-road route R3 to the off-road destination D.

After received the aforesaid three suggested routes, the vehicle M displays the data on the display screen of the second navigation apparatus 23 for selection by the driver. For example, the driver can select the combination of the simple guiding route G2 and the venturesome specific off-road route R2. After selection, the second navigation apparatus 23 of the vehicle M start to fetch the data of the current position C2 of the vehicle M from the GPS module 21, and then to compare the fetched data to the guiding route G2 stored in the memory 25 for guiding the vehicle M to the starting point S2 through accomplished roads, and then to compare the fetched data to the corresponding specific off-road route R2 stored in the memory 25 for guiding the vehicle M from the starting point S2 to the wild stream hot spring located at the off-road destination D.

Instead of the aforesaid guiding route selection method, a selection condition may be set in the memory 25 so that the second navigation apparatus 23 can select one guiding route from the three suggested routes automatically, and then display the data of the selected guiding route on the display screen. The selection condition may be based on the conditions of shortest distance, best traffic condition, venture status, briefness of navigation data, etc. Alternatively, when the wireless communication module 22 receives suggested guiding routes, the second navigation apparatus 23 of the vehicle M may directly compare the suggested guiding routes to the selection condition set in the memory 25, and then reserve one of the suggested guiding routes for use to guide the vehicle M to the off-road destination. Thus, the vehicle M needs not to store the other two suggested guiding routes in the memory 25.

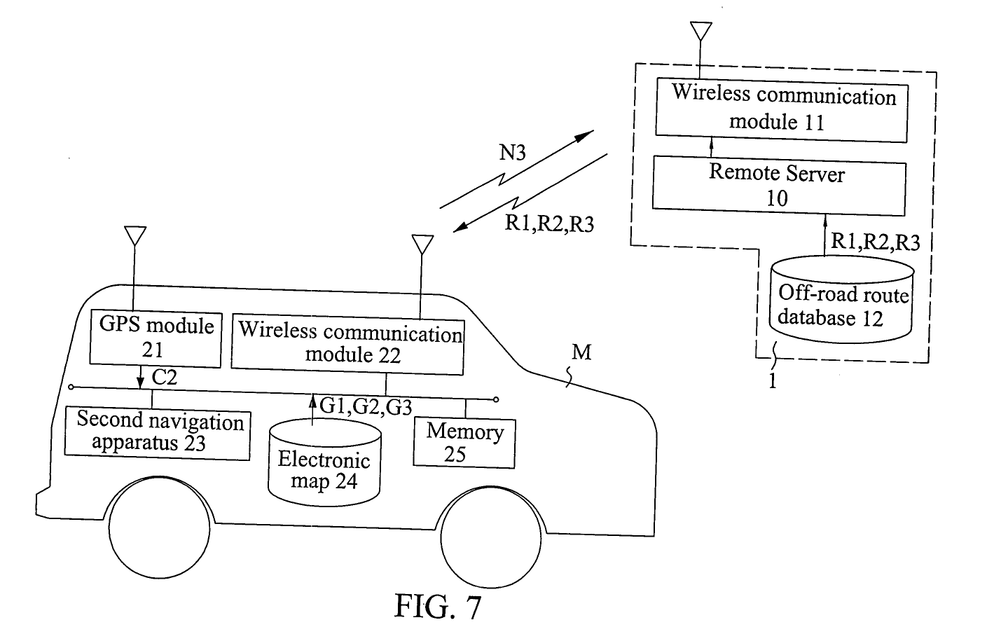

FIG. 7 illustrates the system architecture of the third embodiment of the present invention. This embodiment is substantially similar to the aforesaid first embodiment with the exception of the added electronic map 24, which is installed in the vehicle M, and has stored therein the data of a plurality of accomplished roads.

Therefore, when the driver wishes to drive the vehicle M from the same departure point C2 to the same wild stream hot spring located at the off-road destination D as shown in FIG. 6, the driver uses the wireless communication module 22 to wirelessly send an off-road navigating request N3 including the data of the off-road destination D to the wireless communication module 11 of the remote control center 1. Upon receipt of the off-road navigating request N3, the remote control center 1 searches the off-road route database 12, and obtains three specific off-road routes R1,R2,R3 from the search, and then wirelessly sends the searched data of the three specific off-road routes R1,R2,R3 to the vehicle M, enabling the vehicle M to store the data in the memory 25. The specific off-road routes R1,R2,R3 each have a starting point S1,S2,S3 located on an accomplished road. Upon receipt of the suggested specific off-road routes R1,R2,R3 from the remote control center 1, the navigating apparatus 23 of the vehicle M searches the accomplished roads in the electronic map 24 subject to the starting points S1,S2,S3 of the suggested specific off-road routes R1,R2,R3, and obtains three guiding routes G1,G2,G3 formed based on accomplished roads from the departure point C2 to the respective starting points S1,S2,S3 of the suggested specific off-road routes R1,R2,R3, enabling the three guiding routes G1,G2,G3 to be shown with the suggested specific off-road routes R1,R2,R3 on the display screen for selection by the driver.

In the aforesaid embodiments of the present invention, the memory 25 can be an IC memory card, which can store the aforesaid downloaded specific off-road routes, and can also download and store the content of introduction of off-road routes from the remote control center 1, which content may include texture, graphics, motion pictures, or voice data. Preferably, the off-road navigation system according to the present invention can also compare the received data to the data of the current position of the vehicle M provided by the GPS module 21, so as to further actively report the surrounding scenes stored in the memory 25 on time.

The aforesaid embodiments explain the use of an on-board off-road navigation unit with a remote control center. A PDA (personal digital assistant) or any of a variety of mobile apparatus having installed therein a navigation system may be used with the remote control center 1.

Although the present invention has been explained in relation to its preferred embodiments, it is to be understood that many other possible modifications and variations can be made without departing from the spirit and scope of the invention as hereinafter claimed.

What is claimed is:

1. An off-road navigation system installed in a remote control center, comprising a remote server, a wireless communication module, and an off-road route database, wherein:
said wireless communication module is adapted to wirelessly receive an off-road navigating request which including the position data of an off-road destination, said off-road destination being located at a specific geographical location where no accomplished road can reach;
said off-road route database has stored therein a plurality of off-road routes, said off-road routes including at least one specific off-road route corresponding and reaching to said off-road destination, said off-road routes each having a starting point;
said remote server is adapted to search said off-road route database for said at least one specific off-road route corresponding to the off-road destination of said off-road navigating request, and to control said wireless communication module to wirelessly send out said at least one specific off-road route in response to said off-road navigating request.

2. The off-road navigation system as claimed in claim 1, wherein the starting point of said off-road route is located on an accomplished road.

3. The off-road navigation system as claimed in claim 1, wherein said off-road navigating request further includes the position data of a departure point; said remote server has further linked thereto an electronic map and a first navigation apparatus, said electronic map having stored therein the data of a plurality of accomplished roads, said first navigation apparatus being adapted to search said electronic map for at least one guiding route respectively corresponding to said at least one specific off-road route, said at least one guiding route each comprising at least one accomplished road passing from said departure point to the starting point of the corresponding specific off-road route; said wireless communication module is further adapted to wirelessly send out said at least one guiding route in response to said off-road navigating request.

4. The off-road navigation system as claimed in claim 3, wherein said off-road navigating request is wirelessly sent from a vehicle, and said departure point is the current position of the vehicle sending said off-road navigating request.

5. An on-board off-road navigation system installed in a vehicle, comprising:
a global positioning module adapted to calculate the current position of said vehicle;
a wireless communication module adapted to wirelessly send out an off-road navigating request and to wirelessly receive at least one specific off-road route, said off-road navigating request including the position data of an off-road destination, said off-road destination being located at a specific geographical location where no accomplished road can reach, said at least one specific off-road route each including an off-road navigation data traveling from a respective starting point to said off-road destination; and
a second navigation apparatus adapted to fetch the current position of said vehicle from said global positioning module, and to guide said vehicle to said off-road destination subject to the off-road navigation data of said at least one specific off-road route.

6. The on-board off-road navigation system as claimed in claim 5, wherein the starting point of said off-road route is located on an accomplished road.

7. The on-board off-road navigation system as claimed in claim 5, wherein said wireless communication module is further adapted to wirelessly receive at least one guiding route which corresponding to said at least one specific off-road route respectively, said at least one guiding route each comprising at least one accomplished road passing from the current position of said vehicle to the starting point of the corresponding specific off-road route.

8. The on-board off-road navigation system as claimed in claim 5, further comprising an electronic map, said electronic map having stored therein the data of a plurality of accomplished roads, said electronic map being linked to said second navigation module such that said second navigation module is capable of searching said electronic map for at least one guiding route respectively corresponding to said at least one specific off-road route, said at least one guiding route each comprising at least one accomplished road passing from the current position of said vehicle to the starting point of the corresponding specific off-road route.

9. The on-board off-road navigation system as claimed in claim 5, further comprising a memory means adapted to store said at least one specific off-road route.

10. The on-board off-road navigation system as claimed in claim 9, wherein said memory means comprises at least one IC memory card.
